(19) United States
(12) Patent Application Publication
(10) Pub. No.: US 2024/0078594 A1
(43) Pub. Date: Mar. 7, 2024

(54) DYNAMIC GENERATION OF A VIRTUAL ENVIRONMENT BASED ON USER-SPECIFIC CRITERIA

(71) Applicant: Shopify Inc., Ottawa (CA)

(72) Inventor: Austin Hoefs, West Allis, WI (US)

(21) Appl. No.: 17/930,217

(22) Filed: Sep. 7, 2022

(51) Int. Cl. G06Q 30/06; G06T 19/00

(52) U.S. Cl. CPC G06Q 30/0643; G06Q 30/0631; G06Q 30/0633; G06T 19/003; G06T 19/006

(57) ABSTRACT

Systems and methods are disclosed herein for dynamically generating a virtual environment based on user-specific criteria. In one embodiment, a computer-implemented method comprises selecting a set of virtual stores for a virtual environment for a particular user based on one or more user-specific criteria associated to the particular user and sending, to a client device, information for rendering the virtual environment. The virtual environment comprises a defined set of virtual storefront positions and a set of virtual storefronts corresponding to the set of virtual stores, wherein virtual storefronts of the set of virtual storefronts are located at positions selected from the defined set of virtual storefront positions. In this manner, the virtual environment and, more specifically the virtual storefronts in the virtual environment, are dynamically updated based on user-specific criteria.

### TECHNICAL FIELD

The present disclosure relates to virtual environments and, more specifically, to dynamically rendering and repositioning of virtual models within a virtual environment.

### BACKGROUND

A virtual environment is a computer-generated environment in which a user is able to interact with objects within the virtual environment and potentially also interact with other users within the virtual environment. In general, a user is represented within a virtual environment by, e.g., an avatar within the virtual environment, and the user is able to control the avatar to move around within the virtual environment and interact with objects within the virtual environment and potentially other users within the virtual environment. One example of a virtual environment is a video game; however, virtual environments may also be generated to replicate real-world environments such as, e.g., office buildings, homes, shopping centers, or the like.

### SUMMARY

Systems and methods are disclosed herein for dynamically generating a virtual environment based on user-specific criteria. In one embodiment, a computer-implemented method comprises selecting a set of virtual stores for a virtual environment for a particular user based on one or more user-specific criteria associated to the particular user and sending, to a client device, information for rendering the virtual environment. The virtual environment comprises a defined set of virtual storefront positions and a set of virtual storefronts corresponding to the set of virtual stores, wherein virtual storefronts of the set of virtual storefronts are located at positions selected from the defined set of virtual storefront positions. In this manner, the virtual environment and, more specifically the virtual storefronts in the virtual environment, are dynamically updated based on user-specific criteria.

In one embodiment, the computer-implemented method further comprises obtaining information related to one or more shopping-related actions of the particular user associated with the virtual environment, selecting a second set of virtual stores for a second virtual environment for the particular user based on one or more of the one or more user-specific criteria and the information related to the one or more shopping-related actions, and sending, to the client device, further information for rendering the second virtual environment, the second virtual environment comprising a second defined set of virtual storefront positions and a second set of virtual storefronts corresponding to the second set of virtual stores selected for the particular user, wherein virtual storefronts of the second set of virtual storefronts are located at positions selected from the second defined set of virtual storefront positions. In this manner, the virtual storefronts are dynamically updated based on both the user-specific criteria and the information related to the one or more shopping-related actions of the particular user.

In one embodiment, the one or more shopping-related actions comprise purchasing an item or placing an item in a shopping cart of the particular user. In one embodiment, the one or more of the one or more user-specific criteria comprise a list of items of interest to the particular user.

In one embodiment, the steps of selecting the second set of virtual stores for the virtual environment for the particular user and sending, to the client device, the further information for rendering the second virtual environment are performed in response to one or more of a defined set of triggering actions. In one embodiment, the defined set of triggering actions comprises any one or more of: entering a virtual store, exiting a virtual store, or changing a field of view of the particular user within the virtual environment.

In one embodiment, the method further comprises, for at least one of the set of virtual stores, selecting a set of items to be presented in the virtual storefront of the at least one of the set of virtual stores based on one or more of the one or more user-specific criteria associated to the particular user. Sending the information for rendering the virtual environment comprises sending the information for rendering the virtual environment such that the virtual environment further comprises the set of items located in the virtual storefront of the at least one of the set of virtual stores. In one embodiment, the method further comprises obtaining information related to one or more shopping-related actions of the particular user associated to the virtual environment and, for the at least one of the set of virtual stores, selecting a second set of items to be presented in the virtual storefront of the at least one of the set of virtual stores based on one or more of the one or more user-specific criteria associated to the particular user and the information related to the one or more shopping-related actions of the particular user associated to the virtual environment. The method further comprises sending, to the client device, further information for rendering a second virtual environment such that the second virtual environment comprises the virtual storefront and the second set of items in the virtual storefront of the at least one of the set of virtual stores.

In one embodiment, the method further comprises, for a given virtual store from among the set of virtual stores, the given virtual store being a virtual store into which the particular user has entered in association with a previous virtual environment, selecting a set of items for the particular user based on one or more of the one or more user-specific criteria associated to the particular user, wherein sending information for rendering the virtual environment comprises sending the information for rendering the virtual environment such that the virtual environment further comprises the items of the set of items located in positions selected from the defined set of item positions within the given virtual store. In one embodiment, the method further comprises obtaining information related to one or more shopping-related actions of the particular user within the given virtual store, selecting a second set of items for the particular user based on one or more of the one or more of the one or more user-specific criteria associated to the particular user and the information related to the one or more shopping-related actions of the particular user within the given virtual store, and sending, to the client device, further information for rendering a second virtual environment, the second virtual environment comprising the given virtual store and a second defined set of item positions within the given virtual store, wherein items of the second set of items are located in positions selected from the second defined set of item positions within the given virtual store. In one embodiment, the one or more shopping-related actions comprise purchasing an item or placing an item in a shopping cart of the particular user. In one embodiment, the one or more user-specific criteria comprise a list of items of interest to the particular user.

In one embodiment, selecting the set of virtual stores for the virtual environment for the particular user comprises selecting the set of virtual stores for the virtual environment for the particular user based on the one or more user-specific criteria associated to the particular user and real-time inventory information for a plurality of virtual stores comprising the set of virtual stores.

Corresponding embodiments of a computer system are also disclosed. In one embodiment, a computing system comprises a network interface and processing circuitry associated with the network interface. The processing circuitry is configured to cause the computing system to select a set of virtual stores for a virtual environment for a particular user based on one or more user-specific criteria associated to the particular user and send, to a client device, information for rendering the virtual environment, the virtual environment comprising a defined set of virtual storefront positions and a set of virtual storefronts corresponding to the set of virtual stores, wherein virtual storefronts of the set of virtual storefronts are located at positions selected from the defined set of virtual storefront positions.

In one embodiment, a non-transitory computer-readable medium comprising instructions executable by processing circuitry of a computing system is provided whereby the computing system is operable to select a set of virtual stores for a virtual environment for a particular user based on one or more user-specific criteria associated to the particular user and send, to a client device, information for rendering the virtual environment, the virtual environment comprising a defined set of virtual storefront positions and a set of virtual storefronts corresponding to the set of virtual stores, wherein virtual storefronts of the set of virtual storefronts are located at positions selected from the defined set of virtual storefront positions.

### BRIEF DESCRIPTION OF THE DRAWINGS

Embodiments will be described, by way of example only, with reference to the accompanying figures wherein:

FIG. 1 illustrates one example of a system in which embodiments of the present disclosure may be implemented;

FIGS. 2A and 2B are a flow chart that illustrates the operation of the virtual environment generation function of FIG. 1 in accordance with an embodiment of the present disclosure;

FIG. 3 is a flow chart that illustrates the operation of the virtual environment generation function of FIG. 1 in accordance with another embodiment of the present disclosure;

FIG. 4 is a schematic block diagram of one example embodiment of the computing system of FIG. 1;

FIG. 5 illustrates an example e-commerce platform, according to one embodiment; and

FIG. 6 depicts a non-limiting embodiment for a home page of an administrator.

Like reference numerals are used in the drawings to denote like elements and features.

### DETAILED DESCRIPTION OF EMBODIMENTS

E-commerce providers are continuously looking for new ways to engage with potential customers. With the increasing popularity of virtual reality solutions (e.g., virtual reality headsets) as well as more traditional virtual environments such as two-dimensional (2D) and three-dimensional (3D) virtual environments rendered on devices such as personal computers, gaming systems, smart phones, and the like, one new way for e-commerce providers to engage with customers is via a virtual e-commerce environment (e.g., a virtual shopping mall containing many virtual stores, a virtual city street(s) along which virtual stores are located, or the like). In such a virtual e-commerce environment, there may be many virtual stores (e.g., hundreds or thousands of virtual stores) and there is a desire to make the shopping experience as convenient and enjoyable to users/customers as possible.

One issue is that there may be many more virtual stores available to a user in a virtual e-commerce environment than in a traditional real-world marketplace (e.g., mall, shopping center, city street, or the like). If all of the virtual stores were to be positioned in the virtual e-commerce environment in a static manner, then the user may be forced to “walk” very long distances through the virtual e-commerce environment to go from one virtual store of interest to another. This would be cumbersome and time consuming and would result in a rather unenjoyable shopping experience. In addition, having such a large number of virtual stores within a virtual e-commerce environment would consume an enormous amount of computer resources (e.g., processing resources, memory resources, network resources, etc.) such that there is a desire from an implementation perspective to have fewer virtual stores.

Unlike a real-world, physical marketplace, by intelligently generating and rendering a virtual e-commerce environment in a computer system, the virtual e-commerce environment can be manipulated in a user-specific manner to improve the shopping experience of each particular user. In this regard, systems and methods are disclosed herein for generating a virtual environment (e.g., a virtual e-commerce environment) to be rendered to a user (e.g., at an associated computing device), where virtual storefronts included within an area around the user's avatar (or other representation of the user) within the virtual environment (e.g., within a field of view of the user within the virtual marketplace) are dynamically updated based on one or more user-specific criteria. In this manner, the virtual environment can be customized specifically to that particular user. By doing so, the user's experience can be improved while at the same time fewer resources are consumed in both generating the virtual environment and communicating information representing the virtual environment to the computing device on which the virtual environment is rendered for the user.

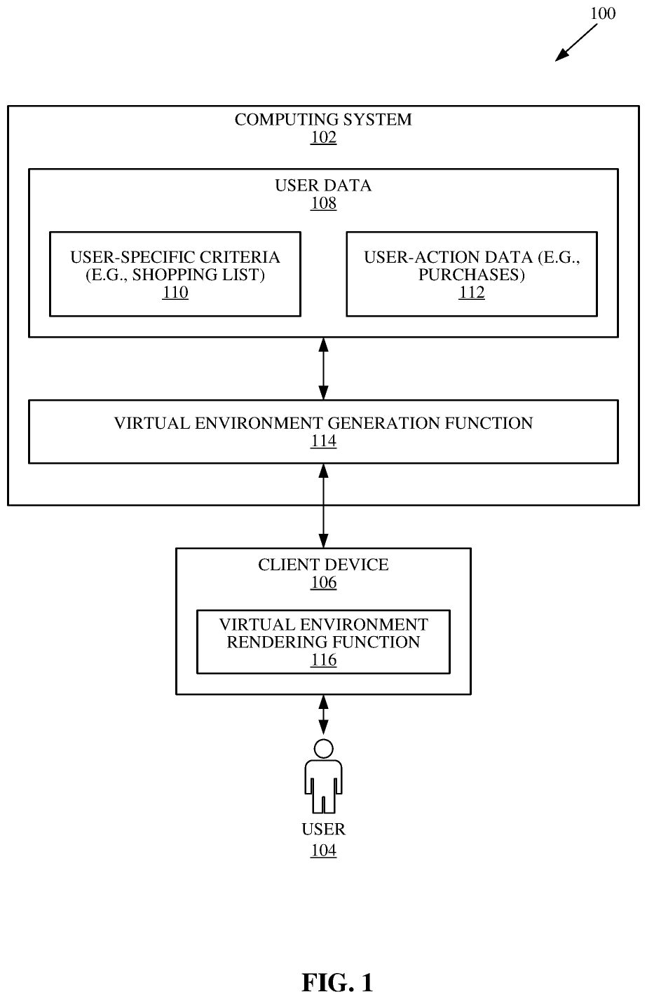

FIG. 1 illustrates one example of a system 100 in which embodiments of the present disclosure may be implemented. As illustrated, the system 100 includes a computing system 102 that generates a virtual environment for a user 104 and sends information for rendering the virtual environment to a client device 106 associated with the user 104 where the virtual environment is rendered to the user 104. The computing system 102 may be, for example, any type of computer system (e.g., a server computer, multiple networked computers providing a “cloud” based computer system, or the like). The computing system 102 stores or otherwise has access to user data 108 including user-specific criteria 110 and user-action data 112.

The computing system 102 also includes a virtual environment generation function 114, which may, for example, be implemented in software or a combination of hardware and software. As described below in detail, during operation, the virtual environment generation function 114 generates a virtual environment to be rendered to the user 104 based on the user-specific criteria 110 and the user-action data 112 for the user 104. More specifically, the virtual environment includes a set of defined storefront locations (e.g., in an area around or near the location of an avatar of the user 104 within the virtual environment), and the virtual environment generation function 114 selects a set of stores for which corresponding storefronts are to be positioned in at least some of the set of defined storefront locations based on the user-specific criteria 110 of the user 104. The user-specific criteria 110 may include, for example, a list of products and/or services in which the user 104 has an interest (e.g., a shopping list or a wish list of the user). In this manner, the selected set of stores include stores in which the products and/or services of interest to the user 104 (and possibly related products and/or services) are sold. The virtual environment generation function 114 thereafter dynamically updates the virtual environment based on the user-action data 112 collected for the user 104. For example, the user-action data 112 may include one or more types of actions that are related to purchases made by the user 104 in the virtual environment and possibly external to the virtual environment. For instance, the user-action data 112 may include a purchase history of the user 104. In this regard, as the user 104 shops in the virtual environment and purchases products and/or services (e.g., products and/or services in the above shopping list or a wish list), the virtual environment may be dynamically updated to, e.g., remove virtual storefronts associated with stores that sell the products/services that the user 104 has already purchased (or at least move those storefronts away from the user 104 within the virtual environment to allow other storefronts to be moved closer to the user 104). The virtual environment generation function 114 sends, to the client device 106, information for rendering the virtual environment to the user 104.

The client device 106 may be, for example, a personal computer, a gaming console, a tablet computer, a smartphone, a Virtual Reality (VR) headset, or the like. The client device 106 includes a virtual environment rendering function 116 that renders the virtual environment to the user 104 based on the information received from the virtual environment generation function 114. The virtual environment rendering function 116 may be implemented, e.g., in software or a combination of hardware and software.

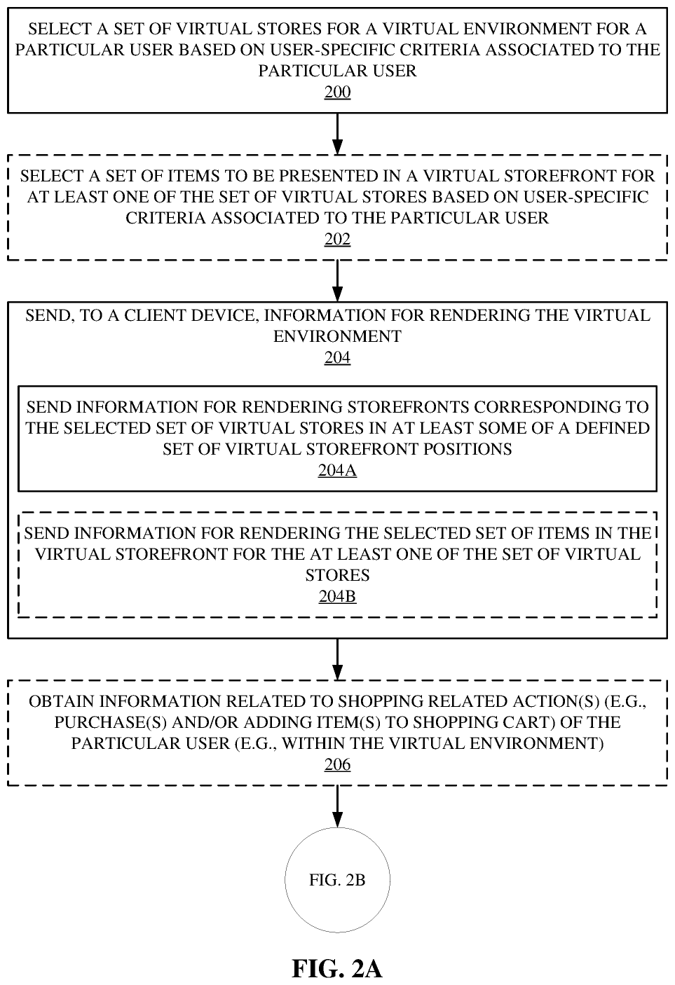

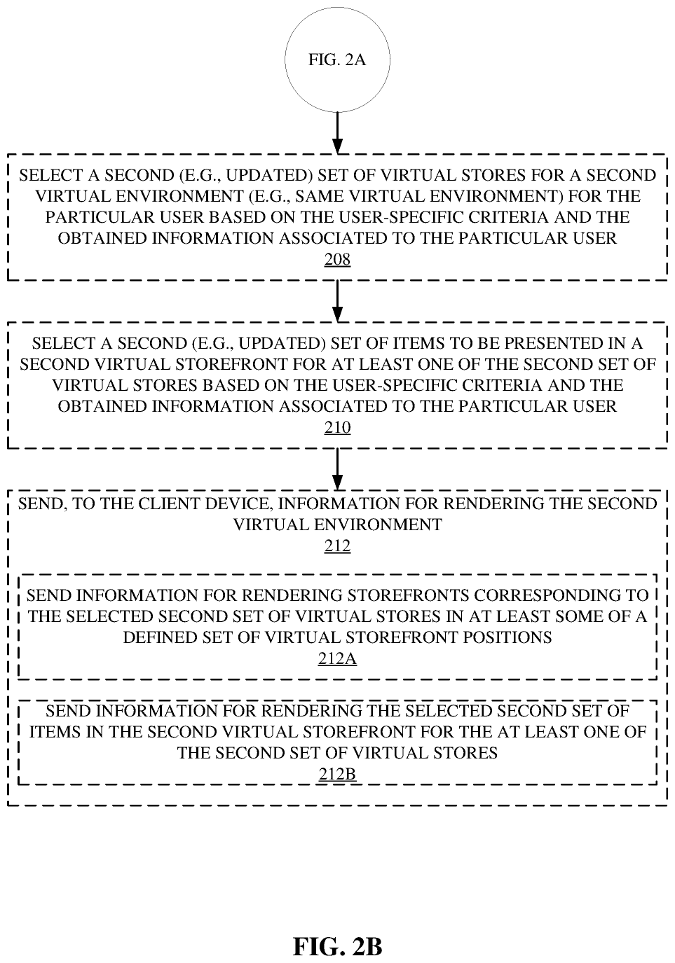

FIGS. 2A and 2B are a flow chart that illustrates the operation of the virtual environment generation function 114 in accordance with an embodiment of the present disclosure. Note that optional steps or aspects are represented by dashed boxes. As illustrated, the virtual environment generation function 114 selects a set of virtual stores for a virtual environment for the user 104 based on the user-specific criteria 110 associated to the user 104 (step 200). In one embodiment, the user-specific criteria 110 includes a list of products and/or services in which the user 104 has an interest (e.g., a shopping list or a wish list of the user). Based on this list, the virtual environment generation function 114 selects, from a defined set of virtual stores that may be included in the virtual environment, a set of virtual stores in which the products and/or services of interest to the user 104 (and possibly related products and/or services) are sold.

Optionally, for at least one virtual store from the selected set of virtual stores, the virtual environment generation function 114 selects a set of virtual items to be presented in a virtual storefront for the virtual store within the virtual environment (step 202). This selection may also be based on the user-specific criteria 110 associated to the user 104. For example, if the user-specific criteria 110 includes a list of products and/or services of interest to the user 104, then the selected set of virtual items may include one or more products and/or services that are sold by the virtual store that are of interest to the user 104 or related to products and/or services that are of interest to the user 104. Note that, as used herein, a “virtual item” is an item in the virtual environment that represent any type of real-world good or service (i.e., a good or service consumed or used by the purchaser in the real world) or virtual good or service (i.e., a good or service consumed or used by the purchaser in a virtual world or virtual environment). An example of a real-world good is an item of clothing (e.g., shirt, pair of shoes, hat, or the like that, if purchased is, e.g., shipped to the purchaser), a digital asset (e.g., a song, a movie, a software product, or the like that, if purchased, is, e.g., downloaded to an electronic device of the purchaser or the like), or the like; however, there are countless other types of real-world goods. An example of a real-world service is an automobile care service (e.g., washing a car, waxing a car, or the like); however, there are countless other types of real-word services. An example of a virtual good or service is any type of good or service that is consumed by the purchaser in a virtual environment (e.g., exists in a virtual environment.

The virtual environment generation function 114 sends, to the client device 106, information for rendering the virtual environment in accordance with the selection of step 200 and optionally the selection of step 202 (step 204). More specifically, this information includes information for rendering virtual storefronts corresponding to the selected set of virtual stores in at least some of a defined set of virtual storefront positions within the virtual environment (step 204A). In other words, for each of the virtual storefronts that corresponds to a respective one of the selected set of virtual stores, the information includes information for rendering the virtual storefront in a respective one of the defined set of virtual storefront positions. Note that the virtual storefronts for the selected set of virtual stores may be assigned to virtual storefront positions in any desired manner. For example, the virtual storefronts may be prioritized based on the user-specific criteria 110 where higher-priority virtual storefronts are assigned to virtual storefront positions that are closer to an avatar of the user 104 within the virtual environment. This prioritization may be based on, e.g., whether the virtual storefront sells products and/or services of interest to the user 104 (e.g., a virtual storefront for a virtual store that sells products and/or services of interest to the user 104 may be assigned a higher priority than a virtual storefront for a virtual store that sells only products and/or services related to those of interest to the user 104). The prioritization may also be based on a defined level of interest in the associated product(s) and/or service(s), where this defined level of interest may be explicitly indicated in the user-specific criteria 110 or implied by the user-specific criteria 110 (e.g., items that appear first in a shopping list are assumed to have higher priority than items that appear later in the shopping list).

In a similar manner, the information sent to the client device 106 in step 204 may also include information for rendering the selected set of virtual items (from step 202) in a defined set of virtual item positions within the respective storefront (step 204B). Here, these items presented within the virtual storefront are items that are visible to the user 104 before the user 104 enters the virtual store.

Sometime thereafter, the virtual environment generation function 114 obtains information related to shopping related action(s) of the user 104, e.g., within the virtual environment (step 206). These shopping related action(s) may be included in the user-action data 112 and may include purchasing a product or service and/or adding a product or service to a shopping cart of the user 104. This information may be obtained real-time as these actions occur or may be obtained near-real-time (e.g., the virtual environment generation function 114 obtains such data periodically, e.g., every X seconds).

Based on the information from step 206 and optionally the user-specific criteria 110, the virtual environment generation function 114 performs a dynamic update. More specifically, the virtual environment generation function 114 selects a second (e.g., updated) set of virtual stores for a second virtual environment for the user 104 based on the user-specific criteria 110 and the obtained information related to shopping related actions of the user 104 (step 208). Note that the “second” virtual environment may be the same virtual environment as above but where the virtual environment is updated based on the second set of virtual stores. For example, the second set of virtual stores may be selected to include virtual stores that sell products and/or services of interest to the user (as indicated by the user-specific criteria 110) that have not already been purchased by the user 104 (as indicated by the obtained information related to the shopping related actions of the user 104). Virtual stores that sell products and/or services that have already been purchased by the user 104 may be excluded from the second set of virtual stores.

The virtual environment generation function 114 may also generate a second (e.g., updated) set of items to be presented in a second virtual storefront for at least one of the virtual stores in the selected second set of virtual stores, based on the user-specific criteria 110 and the obtained information related to shopping related actions of the user 104 (step 210). For example, the second set of items may be selected to include items of interest to the user 104 (as indicated by the user-specific criteria 110) that have not already been purchased by the user 104 (as indicated by the obtained information related to the shopping related actions of the user 104). Items that have already been purchased by the user 104 may be excluded from the second set of items.

The virtual environment generation function 114 sends, to the client device 106, information for rendering the second virtual environment in accordance with the selection of step 208 and optionally the selection of step 210 (step 212). More specifically, this information includes information for rendering virtual storefronts corresponding to the selected second set of virtual stores in at least some of a defined set of virtual storefront positions within the virtual environment (step 212A). In other words, for each of the virtual storefronts that corresponds to a respective one of the selected second set of virtual stores, the information includes information for rendering the virtual storefront in a respective one of the defined set of virtual storefront positions. Again, the virtual storefronts for the selected set of virtual stores may be assigned to virtual storefront positions in any desired manner. For example, the virtual storefronts may be prioritized based on the user-specific criteria 110 where higher-priority virtual storefronts are assigned to virtual storefront positions that are closer to an avatar of the user 104 within the virtual environment.

In a similar manner, the information sent to the client device 106 in step 212 may also include information for rendering the selected second set of virtual items (from step 210) in a defined set of virtual item positions within the respective storefront (step 212B). Here, these items presented within the virtual storefront are items that are visible to the user 104 before the user 104 enters the virtual store.

From this point, the process may return to step 206 and repeat as new shopping related actions are collected for the user 104.

It should be noted that dynamic updating of the virtual environment may also be triggered by various actions such as, e.g., movement of the user 104 within the virtual environment, entering a virtual store within the virtual environment, exiting a virtual store within the virtual environment, a change in a field of view of the user 104 within the virtual environment, or the like. When such a triggering event occurs, the procedure may return to, e.g., step 208 such that the virtual environment is updated. Note that, as the user 104 moves within the virtual environment, the defined set of virtual storefront positions may change to reflect the current location of the user within the virtual environment. The virtual environment generation function 114 then performs the procedure above to, e.g., select the virtual stores for which virtual storefronts are to be positioned within at least some of the defined set of virtual storefront positions for the current location (or field of view) of the user 104 within the virtual environment.

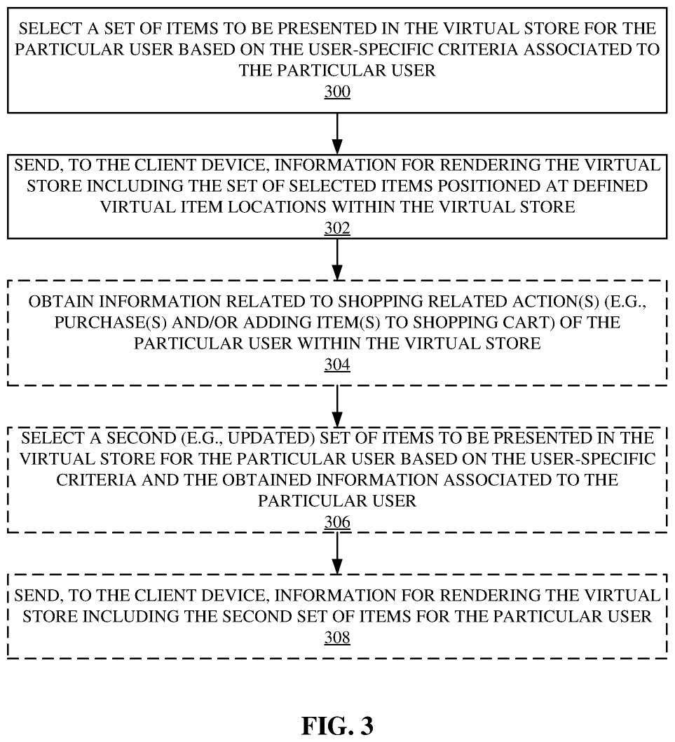

In addition to dynamically updating the virtual storefronts as described above, the virtual environment generation function 114 may also dynamically update virtual items (e.g., virtual products and/or services) positioned in defined virtual item positions within a virtual store after the user 104 has entered the respective virtual storefront. This dynamic updating of virtual items may be performed based on the user-specific criteria 110 and the user-action data 112 of the user 104 in a manner similar to what is described above for the virtual storefronts. In this regard, FIG. 3 is a flow chart that illustrates the operation of the virtual environment generation function 114 in accordance with another embodiment of the present disclosure. Optional steps are represented by dashed boxes. As illustrated in FIG. 3, while the user 104 is present in a virtual store within the virtual environment, the virtual environment generation function 114 selects a set of items (e.g., products and/or services) to be present in the virtual store for the user 104 based on the user-specific criteria 110 associated to the user 104 (step 300). As discussed above, in one embodiment, the user-specific criteria 110 includes a list of products and/or services in which the user 104 has an interest (e.g., a shopping list or a wish list of the user). Based on this list, the virtual environment generation function 114 selects, from a defined set of virtual items sold in the virtual store, a set of virtual items that are sold by the virtual store and match (or are related to) the products and/or services of interest to the user 104. The virtual environment generation function 114 sends, to the client device 106, information for rendering the virtual store such that the selected set of virtual items are positioned in at least some of a set of defined virtual item locations within the virtual store (step 302).

Sometime thereafter, the virtual environment generation function 114 obtains information related to shopping related action(s) of the user 104, e.g., within the virtual store (step 304). These shopping related action(s) may be included in the user-action data 112 and may include purchasing a product or service and/or adding a product or service to a shopping cart of the user 104. This information may be obtained real-time as these actions occur or may be obtained near-real-time (e.g., the virtual environment generation function 114 obtains such data periodically, e.g., every X seconds).

Based on the information from step 304 and optionally the user-specific criteria 110, the virtual environment generation function 114 performs a dynamic update of the virtual store. More specifically, the virtual environment generation function 114 selects a second (e.g., updated) set of virtual items to be presented in the virtual store for the particular user 104 based on the user-specific criteria 110 and the obtained information related to shopping related actions of the user 304 (step 306). For example, the second set of virtual items may be selected to include virtual items sold by the virtual store that are of interest to the user (as indicated by the user-specific criteria 110) and have not already been purchased by the user 104 or placed in the shopping cart of the user 104 (as indicated by the obtained information related to the shopping related actions of the user 104). Virtual items already purchased by the user 104 or already added to the shopping cart of the user 104 may be excluded from the second set of virtual items. The virtual environment generation function 114 sends, to the client device 106, information for rendering the virtual store such that the second selected set of virtual items are positioned in at least some of a set of defined virtual item locations within the virtual store (step 308).

From this point, the process may return to step 304 and repeat as new shopping related actions are collected for the user 104.

It should be noted that dynamic updating of the virtual store may also be triggered by various actions such as, e.g., movement of the user 104 within the virtual store, a change in a field of view of the user 104 within the virtual store, or the like. When such a triggering event occurs, the procedure may return to, e.g., step 306 such that the virtual store is updated. Note that, as the user 104 moves within the virtual store, the defined set of virtual item positions may change to reflect the current location of the user within the virtual store. The virtual environment generation function 114 then performs the procedure above to, e.g., select the virtual items to be positioned within at least some of the defined set of virtual item positions for the current location (or field of view) of the user 104 within the virtual store.

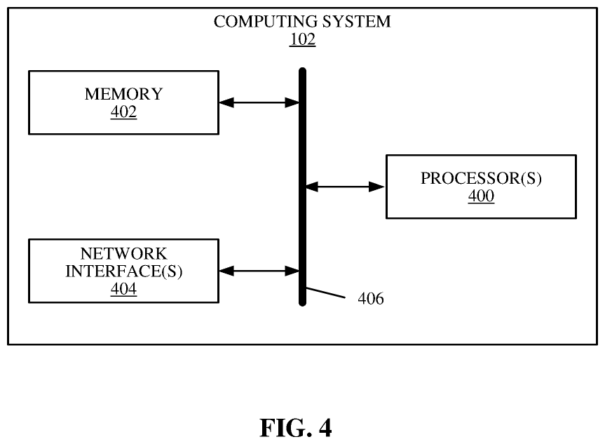

FIG. 4 is a schematic block diagram of one example embodiment of the computing system 102. As illustrated, the computing system 102 includes one or more processors 400 (e.g., Central Processing Units (CPUs), Application Specific Integrated Circuits (ASICs), Field Programmable Gate Arrays (FPGAs), and/or the like), memory 402, and one or more network interfaces 404 (e.g., a Wi-Fi network interface, a cellular (e.g., Fifth Generation (5G)) interface, an Ethernet network interface, or the like), connected via a bus 406 or the like. The processors 400 are also referred to herein as processing circuitry. In some embodiments, the virtual environment generation function 114 described above is implemented in software that is stored in the memory 402 and executed by the processor(s) 400. Note that the computing system 102 may include additional components not illustrated in FIG. 4 such as, e.g., a power supply (e.g., a battery and associated power circuitry), etc.

In some embodiments, a computer program including instructions which, when executed by at least one processor, causes the at least one processor to carry out the functionality of the virtual environment generation function 114 according to any of the embodiments described herein is provided. In some embodiments, a carrier comprising the aforementioned computer program product is provided. The carrier is one of an electronic signal, an optical signal, a radio signal, or a computer-readable storage medium (e.g., a non-transitory computer-readable medium such as memory).

### Example E-Commerce Platform

Although integration with a commerce platform is not required, in some embodiments, the methods disclosed herein may be performed on or in association with a commerce platform such as an e-commerce platform. Therefore, an example of a commerce platform will be described.

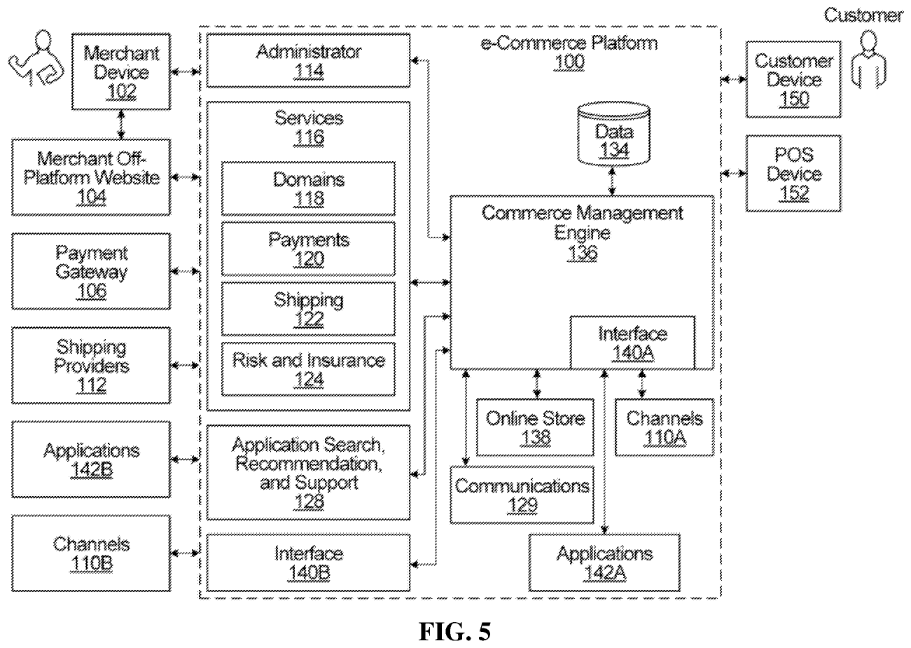

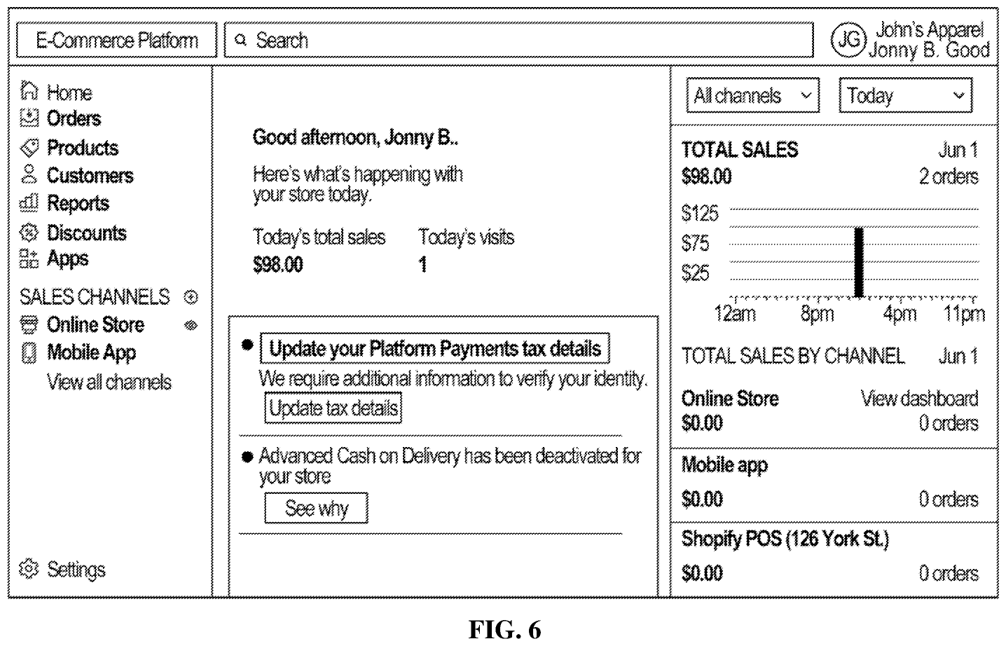

FIG. 5 illustrates an example e-commerce platform 100, according to one embodiment. The e-commerce platform 100 may be exemplary of the e-commerce platform 105 described with reference to FIG. 6. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a “merchant” and a “customer” may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to “merchants” and “customers”, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 5, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point-of-sale (POS) devices 152 in physical locations (e.g., a physical storefront or other location such as through a kiosk, terminal, reader, printer, 3D printer, and the like).

A merchant may utilize the e-commerce platform 100 as a sole commerce presence with customers, or in conjunction with other merchant commerce facilities, such as through a physical store (e.g., “brick-and-mortar” retail stores), a merchant off-platform website 104 (e.g., a commerce Internet website or other internet or web property or asset supported by or on behalf of the merchant separately from the e-commerce platform 100), an application 142B, and the like. However, even these “other” merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through “buy buttons” that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point-of-sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally, or alternatively, it may be that themes can, additionally or alternatively, be customized using theme-specific settings such as, for example, settings as may change aspects of a given theme, such as, for example, specific colours, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment facility 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

FIG. 6 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 6. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a “view all recent activity” dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as, for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 5, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and colour, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

Note that, in one embodiment, the computing system 102 corresponds to the e-commerce platform 100, where the virtual environment generation function 114 may be implemented within the e-commerce platform 100. The user 104 and the client device 106 may correspond to the customer and customer device 150.

### Implementations

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In some embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4th Generation (4G) networks (e.g., Long-Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer-implemented method comprising:
selecting a set of virtual stores for a virtual environment for a particular user based on one or more user-specific criteria associated to the particular user; and
sending, to a client device, information for rendering the virtual environment, the virtual environment comprising a defined set of virtual storefront positions and a set of virtual storefronts corresponding to the set of virtual stores, wherein virtual storefronts of the set of virtual storefronts are located at positions selected from the defined set of virtual storefront positions.

2. The computer-implemented method of claim 1 further comprising:
obtaining information related to one or more shopping-related actions of the particular user associated with the virtual environment;
selecting a second set of virtual stores for a second virtual environment for the particular user based on one or more of the one or more user-specific criteria and the information related to the one or more shopping-related actions; and
sending, to the client device, further information for rendering the second virtual environment, the second virtual environment comprising a second defined set of virtual storefront positions and a second set of virtual storefronts corresponding to the second set of virtual stores selected for the particular user, wherein virtual storefronts of the second set of virtual storefronts are located at positions selected from the second defined set of virtual storefront positions.

3. The method of claim 2 wherein the one or more shopping-related actions comprises purchasing an item or placing an item in a shopping cart of the user.

4. The method of claim 3 wherein the one or more of the one or more user-specific criteria comprise a list of items of interest to the particular user.

5. The method of claim 2 wherein the steps of selecting the second set of virtual stores for the second virtual environment for the particular user and sending, to the client device, the further information for rendering the second virtual environment are performed in response to one or more of a defined set of triggering actions.

6. The method of claim 5 wherein the defined set of triggering actions comprises any one or more of: entering a virtual store, exiting a virtual store, or changing a field of view of the user within the virtual environment.

7. The method of claim 1 further comprising:
for at least one of the set of virtual stores, selecting a set of items to be presented in a virtual storefront of the at least one of the set of virtual stores based on one or more of the one or more user-specific criteria associated to the particular user; and
wherein sending the information for rendering the virtual environment comprises sending the information for rendering the virtual environment such that the virtual environment further comprises the set of items located in the virtual storefront of the at least one of the set of virtual stores.

8. The method of claim 7 further comprising:
obtaining information related to one or more shopping-related actions of the particular user associated to the virtual environment;
for the at least one of the set of virtual stores, selecting a second set of items to be presented in the virtual storefront of the at least one of the set of virtual stores based on one or more of the one or more user-specific criteria associated to the particular user and the information related to the one or more shopping-related actions of the particular user associated to the virtual environment; and
sending, to the client device, further information for rendering a second virtual environment such that the second virtual environment comprises the virtual storefront and the second set of items in the virtual storefront of the at least one of the set of virtual stores.

9. The method of claim 1 further comprising, for a given virtual store from among the set of virtual stores, the given virtual store being a virtual store into which the particular user has entered in association with a previous virtual environment:
selecting a set of items for a particular user based on one or more of the one or more user-specific criteria associated to the particular user; and
wherein sending, to the client device, information for rendering the virtual environment comprises sending the information for rendering the virtual environment such that the virtual environment further comprises the items of the set of items located in positions selected from a defined set of item positions within the given virtual store.

10. The computer-implemented method of claim 9 further comprising:
obtaining information related to one or more shopping-related actions of the particular user within the given virtual store;
selecting a second set of items for the particular user based on one or more of the one or more of the one or more user-specific criteria associated to the particular user and the information related to the one or more shopping-related actions of the particular user within the given virtual store; and
sending, to the client device, further information for rendering a second virtual environment, the second virtual environment comprising the given virtual store and a second defined set of item positions within the given virtual store, wherein items of the second set of items are located in positions selected from the second defined set of item positions within the given virtual store.

11. The method of claim 10 wherein the one or more shopping-related actions comprises purchasing an item or placing an item in a shopping cart of the user.

12. The method of claim 11 wherein the one or more user-specific criteria comprise a list of items of interest to the particular user.

13. The method of claim 1 wherein selecting the set of virtual stores for the virtual environment for the particular user comprises selecting the set of virtual stores for the virtual environment for the particular user based on the one or more user-specific criteria associated to the particular user and real-time inventory information for a plurality of virtual stores comprising the set of virtual stores.

14. A computing system comprising:
a network interface; and
processing circuitry associated with the network interface, the processing circuitry configured to cause the computing system to:
select a set of virtual stores for a virtual environment for a particular user based on one or more user-specific criteria associated to the particular user; and
send, to a client device, information for rendering the virtual environment, the virtual environment comprising a defined set of virtual storefront positions and a set of virtual storefronts corresponding to the set of virtual stores, wherein virtual storefronts of the set of virtual storefronts are located at positions selected from the defined set of virtual storefront positions.

15. The computing system of claim 14 wherein the processing circuitry is further configured to cause the computing system to:
obtain information related to one or more shopping-related actions of the particular user associated with the virtual environment;
select a second set of virtual stores for a second virtual environment for the particular user based on one or more of the one or more user-specific criteria and the information related to the one or more shopping-related actions; and
send, to the client device, further information for rendering the second virtual environment, the second virtual environment comprising a second defined set of virtual storefront positions and a second set of virtual storefronts corresponding to the second set of virtual stores selected for the particular user, wherein virtual storefronts of the second set of virtual storefronts are located at positions selected from the second defined set of virtual storefront positions.

16. The computing system of claim 15 wherein the one or more shopping-related actions comprise purchasing an item or placing an item in a shopping cart of the user.

17. The computing system of claim 16 wherein the one or more of the one or more user-specific criteria comprise a list of items of interest to the particular user.

18. The computing system of claim 15 wherein the processing circuitry is further configured to cause the computing system to perform the steps of selecting the second set of virtual stores for the second virtual environment for the particular user and sending, to the client device, the further information for rendering the second virtual environment are performed in response to one or more of a defined set of triggering actions.

19. The computing system of claim 18 wherein the defined set of triggering actions comprises any one or more of: entering a virtual store, exiting a virtual store, or changing a field of view of the particular user within the virtual environment.

20. A non-transitory computer-readable medium comprising instructions executable by processing circuitry of a computing system whereby the computing system is operable to:
select a set of virtual stores for a virtual environment for a particular user based on one or more user-specific criteria associated to the particular user; and
send, to a client device, information for rendering the virtual environment, the virtual environment comprising a defined set of virtual storefront positions and a set of virtual storefronts corresponding to the set of virtual stores, wherein virtual storefronts of the set of virtual storefronts are located at positions selected from the defined set of virtual storefront positions.
